(19) United States
(12) Patent Application Publication
(10) Pub. No.: US 2017/0100661 A1
(43) Pub. Date: Apr. 13, 2017

(54) VISION SYSTEM FOR MONITORING BOARD GAMES AND METHOD THEREOF

(71) Applicant: CHESS VISION LTD, Rosh HaAyin (IL)

(72) Inventor: Zah Haim SLAV, Sitrya (IL)

(21) Appl. No.: 15/129,100

(22) PCT Filed: Apr. 2, 2015
(86) PCT No.: PCT/IL2015/050357

§ 371 Date: Sep. 26, 2016

(30) Foreign Application Priority Data
Apr. 3, 2014 (IL) 231947

(51) Int. Cl. A63F 3/02; A63F 13/75; A63F 13/213

(52) U.S. Cl. CPC A63F 3/022; A63F 13/213; A63F 13/75; A63F 2009/2435

(57) ABSTRACT

The present invention relates to a method of monitoring a board game, comprising: a) tracking movement and position of game pieces on the game board during a game session by at least one camera adapted to monitor the board game; and b) verifying the correctness of said movement according to rules of the played game and/or tournaments by using a processing device adapted to detect moves and other relevant game data from received board game images and to verify them according to game rules as defined by a game engine.

### FIELD OF THE INVENTION

The present invention relates to the field of monitoring systems. More particularly, the invention relates to a method and system for monitoring board games played by human players in the real world.

### BACKGROUND OF THE INVENTION

A board game is a game that involves counters or pieces moved or placed on a pre-marked surface or “board”, according to a set of rules. Games can be based on pure strategy, chance (e.g. rolling dice), or a mixture of the two, and usually have a goal that a player aims to achieve. There are many varieties of board games and their rules can range from the very simple (e.g. Tic-tac-toe) to those describing a game universe in great detail. Early board games represented a battle between two armies (e.g., Chess), and most modern board games are still based on defeating opposing players in terms of counters, winning position, or accrual of points.

For example, a chess tournament is a series of chess games played competitively to determine a winning individual or team. Most chess tournaments are organized and ruled according to the World Chess Federation (FIDE) handbook, which offers guidelines and regulations for conducting tournaments in addition the original rules of the game. For example, a chess tournament may involve the followings:
A chess clock—a clock having two separate time displays of which only one display can be running at a time. The purpose is to keep track of the total time each player takes for his or her own moves, and to limit the time each player has to think and perform his or her moves. The player with the black pieces will initiate their opponent's timer at the start of the game. Thus the player with the white pieces will have their timer running first, and will make the first move.
Irregularities—If it is found that the starting position of the pieces is incorrect, the game must be cancelled and restarted. If it is found that an illegal move has been made, the game must return to the position directly before the irregularity. For the first two illegal moves by a player, the arbiter shall give two minutes extra time to his opponent each time. If a player is to make a third illegal move in the same game, the arbiter can declare the game lost by the offending player. If a game begins with the piece colors reversed, the game should be stopped and restarted unless an arbiter rules otherwise. If a player displaces any pieces, they should place them in the correct locations on their own time.
Recording of moves—in games with long time controls, each player is required to record all moves of the game in algebraic chess notation. However, if a player reaches less than five minutes on their clock, and does not have a time delay of thirty seconds or more, they are excused from recording the remaining game moves until the game has been completed. At the conclusion of the game, both players must sign each other's scoresheets and turn them to the event organizers if instructed to do so. In fast chess games, players are not required to record moves, as it would take away from important thinking time. The scoresheets must be visible to the arbiter at all times.
Portable Game Notation (PGN)—PGN is a plain text computer-processible format for recording chess games (both the moves and related data), supported by many chess programs. PGN is structured “for easy reading and writing by human users and for easy parsing and generation by computer programs.” The chess moves themselves are given in algebraic chess notation. The usual filename extension is “.pgn”.

It is an object of the present invention to provide a system which is capable of automatically monitoring a game sequence on a game board in real-time.

Other objects and advantages of the invention will become apparent as the description proceeds.

### SUMMARY OF THE INVENTION

The present invention relates to a method of monitoring a board game, comprising:
a) tracking movement and position of game pieces on the game board during a game session; and
b) verifying the correctness of said movement according to rules of the played game and/or the tournaments.

According to an embodiment of the invention, the method further comprises transferring the verified moves to a remote server and converting the verified moves into a commonly used electronic notation format (like PGN in chess).

According to an embodiment of the invention, the method further comprises detecting a sequence of board game moves using a game engine that leads from one game board state to another, wherein the game engine configured to process the moves of players and monitor their compliance with game rules by comparing and matching each received move with pre-stored rules.

According to an embodiment of the invention, the method further comprises recording timing of each move along with the detected moves, thereby enabling to act as a game clock.

According to an embodiment of the invention, the method further comprises enhancing the moves detection by generating key frame signals.

According to an embodiment of the invention, the method further comprises monitoring the usage and state of an electronic chess clock.

According to an embodiment of the invention, the method further comprises simultaneously monitoring multiple game boards using a single camera.

In another aspect, the present invention relates to a system of monitoring board game, comprising:
a) a processing device adapted to detect moves and other relevant game data from received board game images and to verify them according to game rules as defined by a game engine; and
b) at least one camera adapted to monitor a board game by streaming acquired frame images of the game board to the processing device, wherein the at least one camera is positioned in such a way that a full view of the game board will be obtained.

According to an embodiment of the invention, a full view of the game board is obtained from one camera located above the game board.

According to another embodiment, a full view of the game board is obtained from more than one camera, wherein the cameras are positioned in such a way that the lens of each camera will be able to provide at least partial view of the game board, while the combination of each camera view enables to provide a full board view, either in two dimensional (2D) form or three dimensional (3D) form depending on the deployment of the cameras.

According to an embodiment of the invention, the system further comprises a server adapted to receive and store the detected moves and other relevant game data processed by the processing device.

### BRIEF DESCRIPTION OF THE DRAWINGS

In the drawings:

FIG. 1 schematically illustrates a vision system for monitoring a board game, according to an embodiment of the invention;

FIG. 2 schematically illustrates a processing device, according to an embodiment of the present invention;

FIG. 3 schematically illustrates a vision system for monitoring multiple board games, according to an embodiment of the invention;

FIG. 4 is a flowchart showing the initial setup stage of the system, according to an embodiment of the invention;

FIG. 5 is a flowchart showing a per frame system operation, according to an embodiment of the invention; and

FIG. 6A shows an exemplary chess board image frame acquired from a camera;

FIG. 6B schematically illustrates the detection of the chess board location within the frame of FIG. 6A, according to an embodiment of the invention;

FIG. 6C schematically illustrates the registered board of FIG. 6B aligned with 8×8 grid, according to an embodiment of the invention;

FIG. 6D schematically illustrates an 8×8 array of board squares on the registered board of FIG. 6C, according to an embodiment of the invention;

FIGS. 7A-7D schematically illustrate exemplary categories for machine learning, according to an embodiment of the present invention;

FIG. 8A schematically illustrates a Machine Learning result for the initial chess board of FIG. 6A, according to an embodiment of the present invention;

FIG. 8B schematically illustrates a Corresponding matrix of categories of FIG. 8A, according to an embodiment of the present invention; and

FIGS. 9A-9E schematically illustrate an exemplary monitoring process for a detected d2-d4 move on a chess board, according to an embodiment of the present invention.

FIGS. 10A-10B schematically illustrate an exemplary board concealment avoiding and move detection by applying Background Subtraction algorithm(s), according to an embodiment of the invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

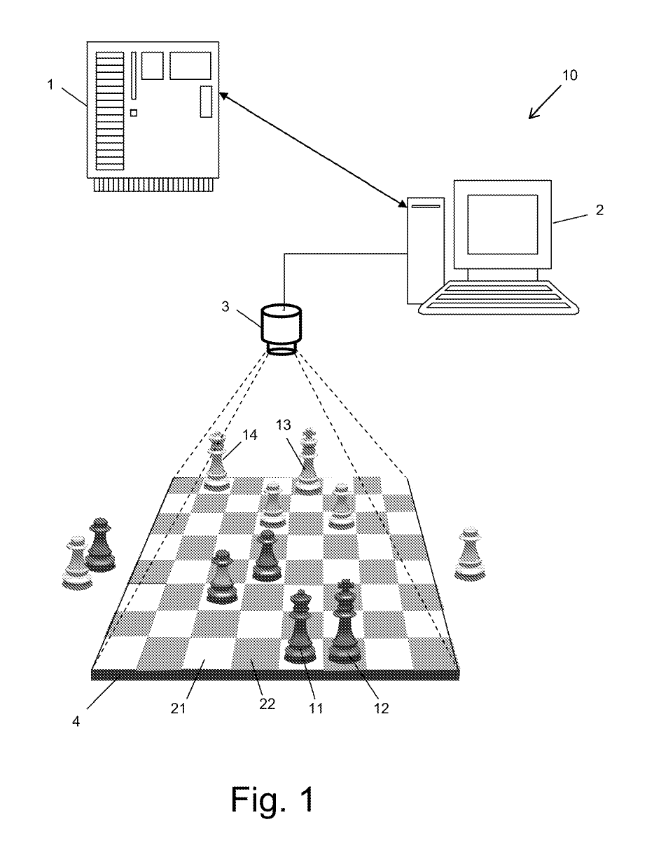

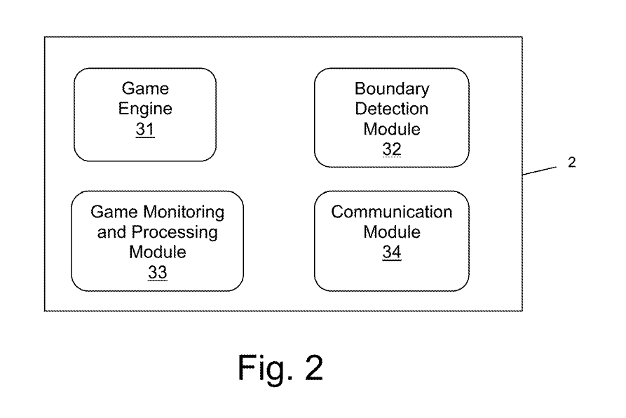

FIG. 1 schematically illustrates a vision system for monitoring board games, according to an embodiment of the invention. The system generally indicated by numeral 10 in the figure comprises a server 1, a processing device 2 and a camera 3 adapted to monitor a board game 4. In some embodiments, processing device 2 and camera 3 can both be parts of a computer based device such as a smartphone or a dedicated device adapted for monitoring a board game.

### System Setup Stage

Camera 3 is positioned in such a way that its lens will be able to provide a view of the game board 4, e.g., an optimal field of view with respect to the game board 4 may include the entire board. For example, the camera 3 can be located above the game board 4 as shown in FIG. 1. The camera 3 streams the acquired frame images of the game board 4 to the processing device 2 (e.g., at rate of 30 frames per second). The processing device 2 stores the acquired frames and processes each of them as will be described in further details hereinafter. Detected moves and other relevant data obtained from the processing is transferred by the processing device 2 on-line to a cloud service for display and storing in the cloud (the cloud service is indicated by the server 1).

### System Initial Setup Stage

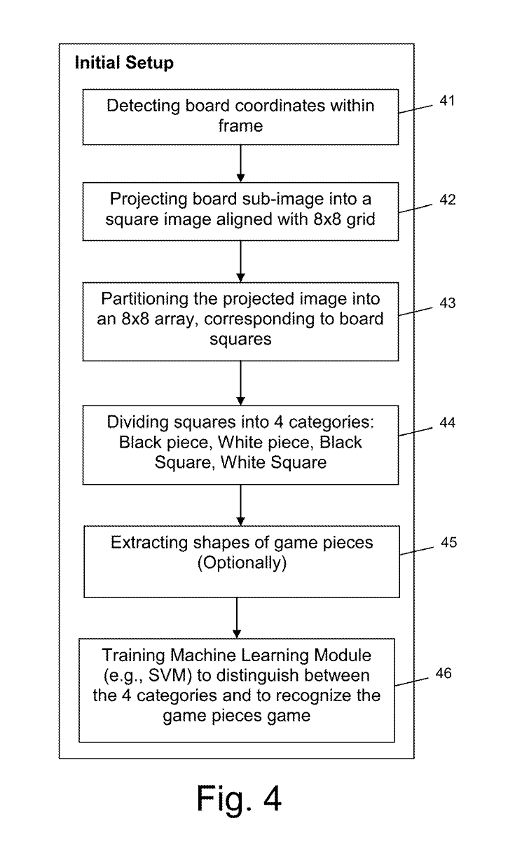

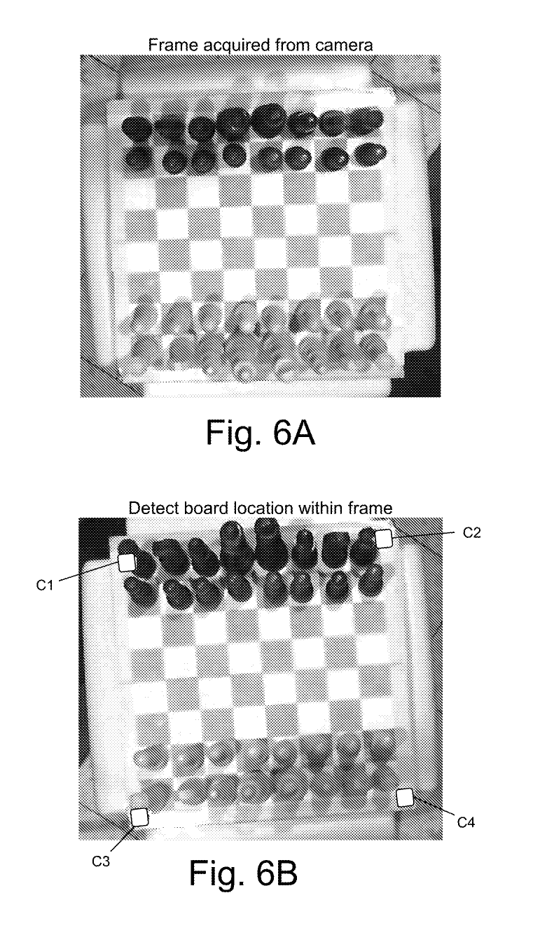

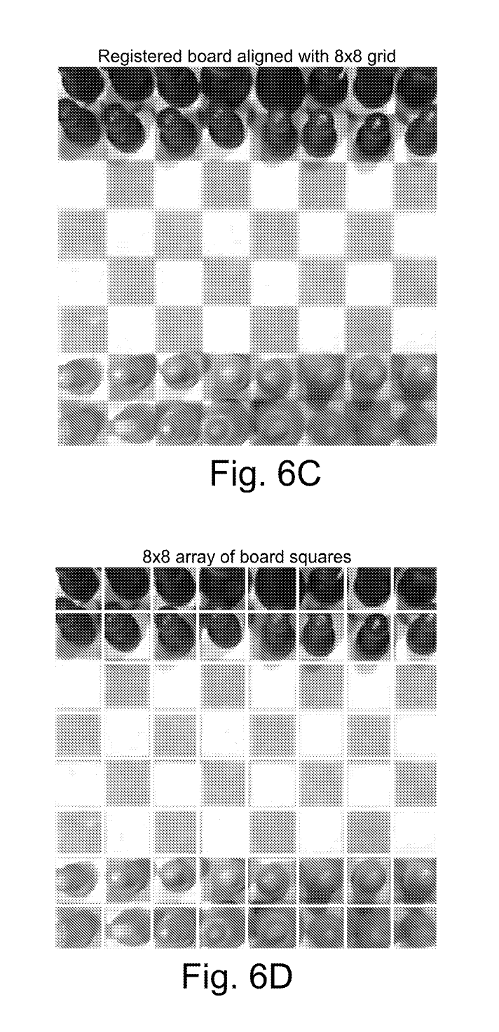

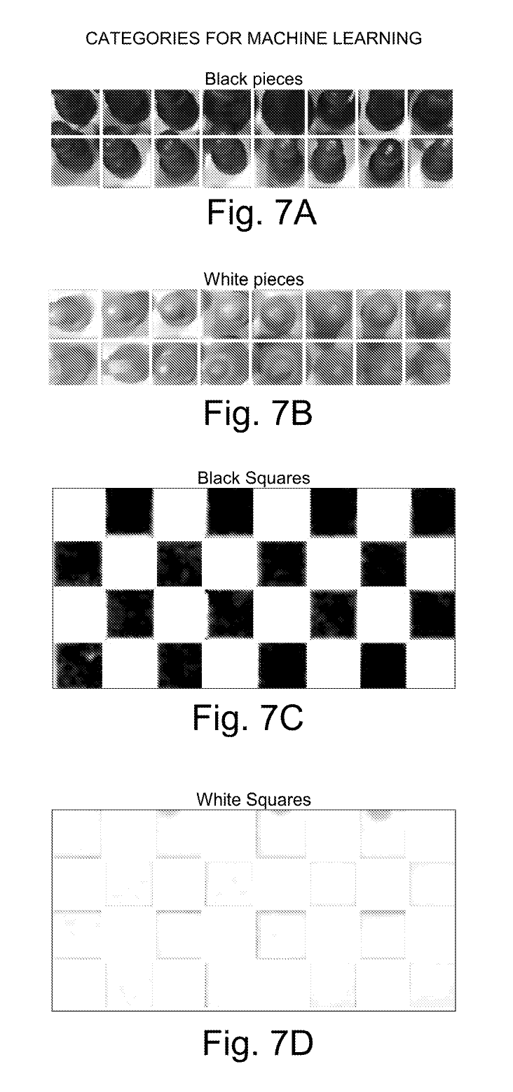

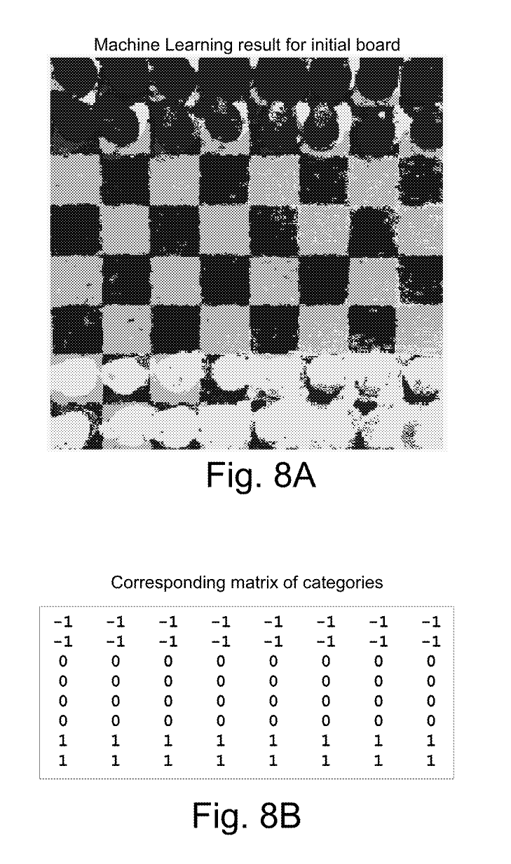

Referring now to FIG. 4, a flowchart illustrating the initial setup stage is show in accordance with an embodiment of the invention. From the first frame (see FIG. 6A that shows a frame acquired from camera 3 of an exemplary top-view image of a chess board), assuming the initial game pieces placement before the game started, the system initial setup involves the following steps:
At block 41, detecting the location of the game board 3 within the frame and records the locations of the corners or boundaries of the game board 4 (as schematically indicated by the dotted line in FIG. 1 that defines the field of view and in the corresponding image of FIG. 6B, where the boundaries of the square board are defined by the four corner indicated by C1, C2, C3 and C4 in the FIG. 6B). The boundary detection can be done by an automatic procedure or manually by an operator via special application interface (e.g., running at the processing device 2);
Projecting sub-image of the board's frame into an image representation aligned with a grid of board squares (block 42, e.g., an 8×8 grid as shown in FIG. 6C);
Partioning the projected image into an array of smaller images (block 43, e.g., an 8×8 array as shown in FIG. 6D) with the content of each squares of the game board 4;
Since the system knows what is expected to be in each board square (such as game pieces and the game board pattern, as indicated, for example, by black pieces 11 and 12, white pieces 13 and 14, white blank square 21, black blank square 22), dividing the array into several categories according the type of game and the game board patterns (block 44) and using it as training data for a machine learning module (block 46, SVM (Support Vector Machine) for instance or other supervised learning models with associated learning algorithms that may analyze data and recognize patterns, used for classification and regression analysis) to distinguish between these categories for future input square images (see FIG. 8A, e.g., the learning criteria can be the color of pixels assuming that they are clearly distinguishable. Optionally, any other image feature extractor can be used to detect and describe local features in images in order to extract shapes of game pieces (block 45) and to train the machine learning module to distinguish between them, like edge detector, texture descriptor, Speeded Up Robust Features (SURF) or other interest point detector/descriptor, Scale-Invariant Feature Transform (SIFT) algorithm, etc.). For example, in a chess game the array is divided into 4 categories:
   black pieces (see FIG. 7A);
   white pieces (see FIG. 7B);
   black blank square (see FIG. 7C);
   white blank square (see FIG. 7D).
An instance of a game engine (e.g., a chess game engine application) is initialized with starting board position, where its function is to process the moves of players and monitor their compliance with game rules.

According to an embodiment of the present invention, the extraction of game pieces shapes can be used as a moves backup feature, which may help to identify one or more moves that have been missed by the system. This may enable to complete missed or undefined moves by the system.

### Per Frame System Operation

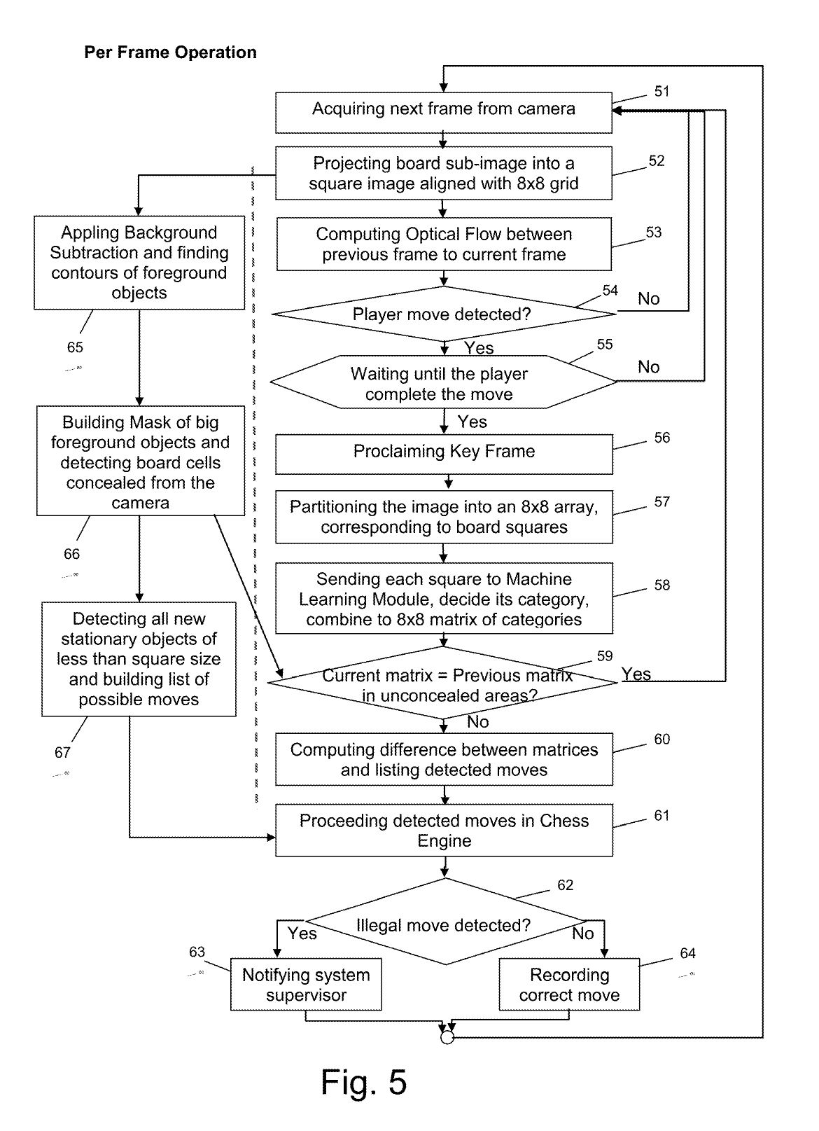

Referring now to FIG. 5, a flowchart illustrating a per frame system operation in accordance with an embodiment of the invention. After the initialization procedure is finished the system enters a loop which may involve the following operations for each frame acquired from the camera 3 (block 51). An image of the game board 4 (after its location was already detected at the initial setup) is extracted and aligned (block 52, e.g., with an 8×8 grid). In case the game board 4 was moved after its detection at the initial setup, its location within the image can be updated in the same manner as done at the initial setup. Each frame of the game board 4 is compared with the previous one, to compute optical flow between them (block 53). Optical flow describes the transition from one frame to another at each pixel, e.g., optical flow may involve the computing of a vector field over a pair of adjusted frames. At block 54, upon detecting that one of the players is currently performing a move, than waiting until the player will end that move (block 55). For example, if certain level of optical flow is detected over the game board 4 which may indicate that one of the players is currently performing a move (e.g., optical flow above a threshold value), then the system will wait until the player will end the move (e.g., the optical flow is less or equal to the threshold value). For example, in order to distinguish between motion/no motion states the system may sum absolute values of vectors the represent the optical flow over the whole image and compare it to a dynamically adapted threshold value, below which it is merely the noise of optical flow calculation.

As soon as motion ceases, a frame is proclaimed as a key frame (block 56) and the following procedure is performed. A key frame refers to a frame at which no motion was detected, immediately following the sequence of frames with motion. It is assumed that board state can't change without an optically noticeable motion over the board, so each time detected motion ceases the system checks if any changes in board state took place. At next, block 57, each key frame of the game board 4 is partitioned into an array of board squares images (e.g., an 8×8 array). At next, block 58, the system sends each square to Machine Learning Module that decides its category and combines to 8×8 matrix of categories. For each square the machine learning system (as trained in system initial setup) is asked to detect whether it is occupied or free, and if occupied, with a piece of which player (white or black). This information is combined into a matrix (e.g., 8×8 matrix as shown in FIG. 8B where the “−1” values represent black pieces, the “1” represent white pieces and the “0” represent blank squares on the chess board), and compared to the corresponding matrix from the previous key frame (block 59). At next, block 60, the differences between the matrixes, if any found, indicate the move or a series of moves that occurred from previous key frame board state to the current one, this changes are translated into standard move notation, square that changed its label from occupied to empty is marked as “FROM” square and previously empty now occupied squire or one which was occupied by an opposite color piece is marked as “TO” square. At next, block 61, this information is passed to a chess engine which maintains the board square from the beginning of the game and for each received move decides whether it complies with the game's rules (block 62). In certain situations, like in speed chess, more than one move can occur from previous key frame to the next one, if such a case detected, the game engine applies a special procedure that tries to figure the sequence of moves that leads from the previous board state to this one relying on the game and tournament rules and may also involve the applying of statistics and inputting of manual information, and if such a unique sequence is found applies it, otherwise in case multiple sequences can fit or an illegal move was detected, system operator is informed (block 63) and his intervention is required in order to fix this situation manually with the provided application interface.

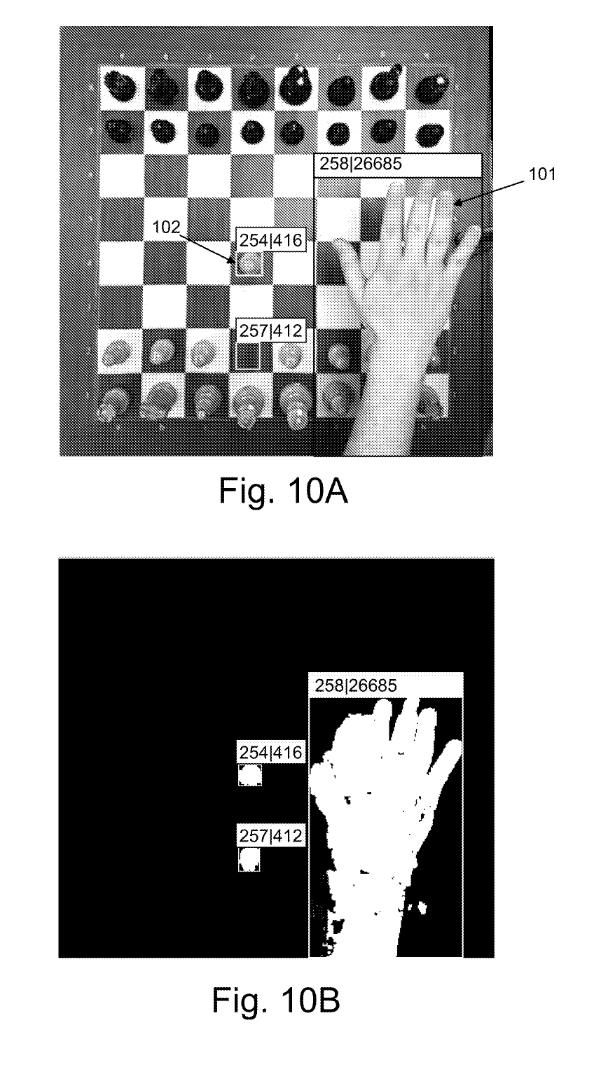

Referring now to FIGS. 10A and 10B, the system may also use an additional technique that can be based on Background Subtraction algorithm to track objects that conceals parts of the board, such as a player hand 101 as indicated in FIG. 10A. The Background Subtraction algorithm can be used in parallel with the optical flow, as indicated by blocks 65-67 in FIG. 5. Background Subtraction maintains the stationary state of a video stream which is considered as background and marks the regions of images which are different from the background to indicate moving objects such as the player's hand 101. The Background Subtraction algorithm may involve the following steps:
Applying Background Subtraction and finding contours of foreground objects (block 65 in FIG. 5);
Building mask of big foreground objects (e.g., as indicated by region “258|26685” in FIGS. 10A and 10B) and detecting board cells concealed from the camera (block 66 in FIG. 5); and
Detecting all new stationary objects of less than square size (e.g., as indicated by squares “257|412” and “254|416” in FIGS. 10A and 10B) and building list of possible moves based on the detected game piece and its allowed moves according to the rules of the game, e.g., move from square “257|412” to square “254|416” (block 66 in FIG. 5).

According to some embodiments of the invention, this marking can be obtained in two ways: first, large moving foreground regions of an image are identified as player's hand or head which conceals parts of the board (as indicated by region “258|26685”) and should be avoided when computing matrix of categories at block 58 of FIG. 5. Secondly, when a game piece 102 was moved from one square to another in the course of game as indicated by squares “257|412” and “254|416” (e.g., move from “257|412” to “254|416”), both squares are indicated as foreground till the background subtraction module applies this change to a background model, and the system tracks such about-square-sized foreground objects (see the interpretation of the computer vision in FIG. 10B), and if any combination of them indicate a legal move, then the system transfers it as well to the chess engine for processing/execution.

At block 64, all key frame images and relevant data produced during the system operation are recorded and stored on the processing device for future reference.

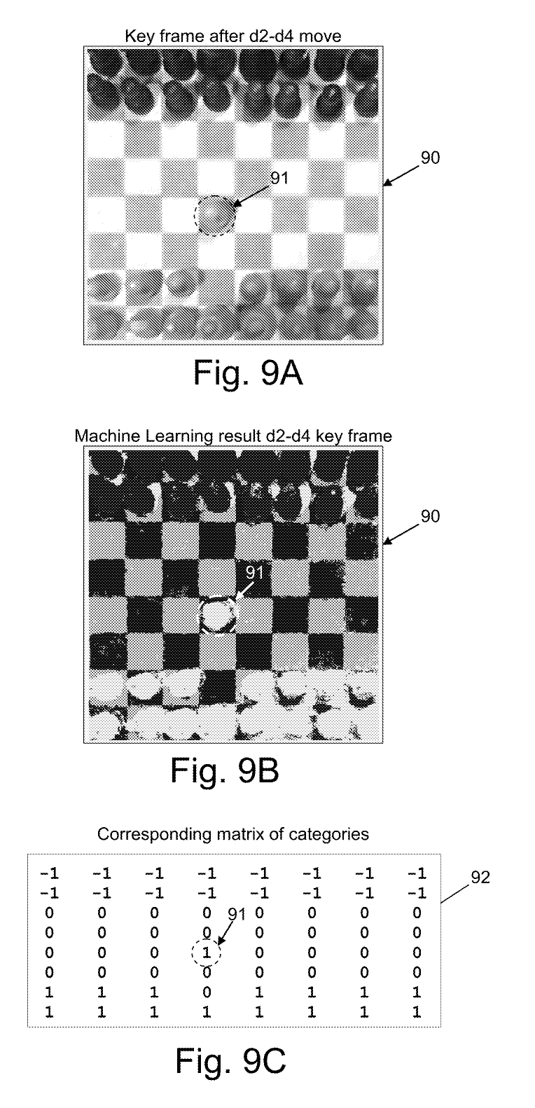

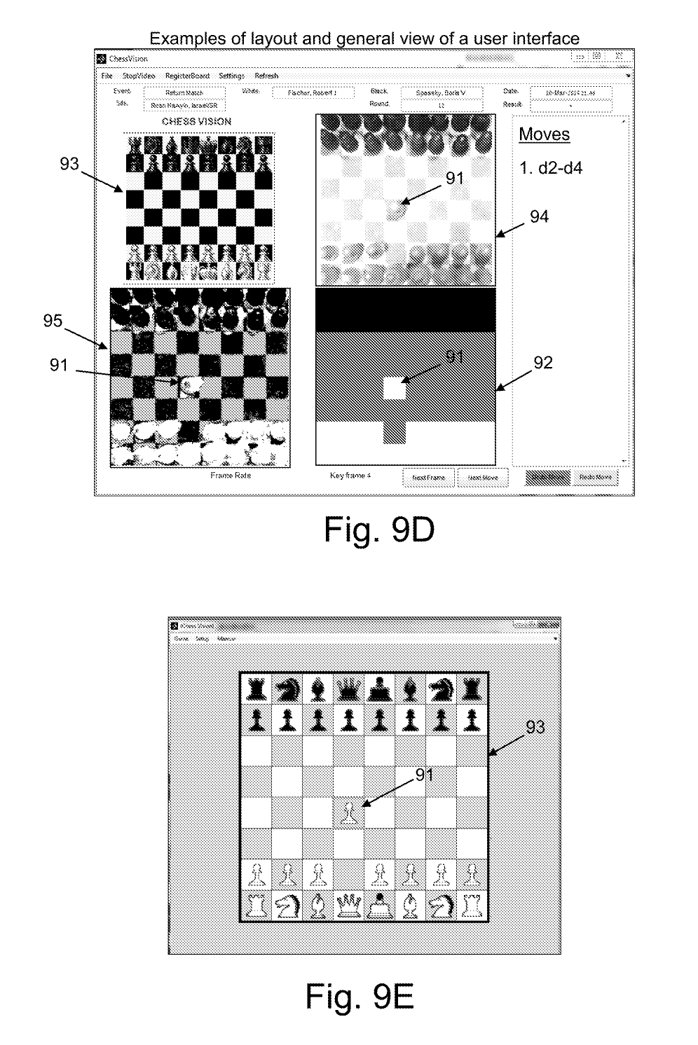

All the above will be better understood through the following illustrative and non-limitative examples as shown in the FIGS. 9A-9D.

FIG. 9A shows an exemplary key frame after a “d2-d4” move of a chess element 91 on a chess board 90. FIG. 9B schematically illustrates the machine learning result of the “d2-d4” key frame shown in FIG. 9A. FIG. 9C shows a matrix of categories corresponding to the machine learning result shown in FIG. 9B. A graphic representation of the matrix is indicated by numeral 92 in FIG. 9D on which chess element 91 is indicated as a white square. FIG. 9D shows an example graphic display layout and general view of the “d2-d4” move in a user interface form, where a computerized representation of the game board 90 of FIG. 9A is indicated by numeral 93. In this exemplary graphic display layout, the key frame of FIG. 9A after the “d2-d4” move is indicated by numeral 94, and the machine learning result of the “d2-d4” key frame of FIG. 9B is indicated by numeral 95. FIG. 9E shows the computerized representation 93 after the “d2-d4” move of chess element 91.

According to an embodiment of the invention, the system (using the processing device and the game engine) further adapted to detect and validate of abnormal and normal game behavior of players. For example, recognizing when a player touches a game piece (since in some game, if a player touches a game piece than he is obligated to play with that piece), in absence of game clock, keeping track of the total time each player takes for his or her own moves, in order to ensure that neither player overly delays the game, identifying the moment when a player complete a move (e.g., when the player leaves the game piece after moving it form one position to another, etc.)

### Game Electronic Clock Monitoring

If an electronic chess clock is present, its state and operation is monitored and recorded, along with board state monitoring. The clock location in the input image is marked by the operator at the initialization step. Assuming that digits on the clock are distinguishable via the camera their location are detected and maintained during the game. The location of the clock's buttons which players press after the move was made is detected, and by measuring the optical flow at that region of image, the precise moment the move was finished can be detected. Digits display region on the clock is extracted and since their structure is known digits display image is divided into separate digit image, then each is passed though machine learning system which determines it value, alternatively the system observes the change in the displayed value, and by comparing it to computer's local time, the system can obtain its value. Switching the clock is also used to generate a key frame procedure call in addition to those detected using optical flow.

### Multiple Boards Monitoring

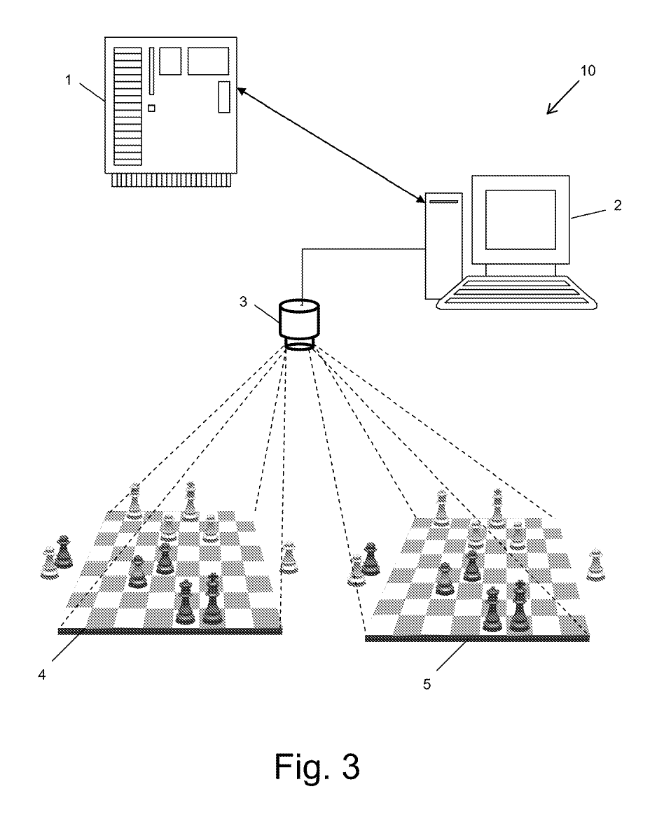

Locating the system's camera above the board allows tracking multiple game boards that fell in the viewport of the camera simultaneously, as shown in FIG. 3 with respect to game boards 4 and 5. At the system initial setup the location of each monitored board is marked within the input image. Then each board image is extracted and treated independently by a dedicated instance of our system.

According to an embodiment of the invention, the system may include a scoring module adapted to provide scoring data to external players scoring systems thereby enabling to update players' ratings after a tournament or match, or after individual games, such as a chess rating system used by the FIDE or the US Chess Federation (USCF).

As will be appreciated by the skilled person the embodiments described hereinabove results in a system and method for automatically monitoring board games, such as chess.

The following discussion is intended to provide a brief, general description of a suitable computing environment in which the invention may be implemented. While the invention described hereinabove in the general context of program modules that execute in conjunction with an application program that runs on an operating system on a processing device 2, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Therefore, embodiments of the invention as described hereinabove may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Although, the functions described herein may be performed by executable code and instructions stored in computer readable medium and running on one or more processor-based systems. It will be apparent to a person skilled in the art that state machines, and/or hardwired electronic circuits can also be utilized. Further, with respect to the example processes described hereinabove, not all the process states need to be reached, nor do the states have to be performed in the illustrated order. Further, certain process states that are illustrated as being serially performed can be performed in parallel.

Similarly, while certain examples may refer to a processing device in form of a Personal Computer (PC) system, other computer or electronic systems can be used as well, such as, without limitation, a tablet, a network-enabled personal digital assistant (PDA), a network game console, a networked entertainment device, a smart phone and so on.

All the above description and examples have been given for the purpose of illustration and are not intended to limit the invention in any way. Many different mechanisms, methods of analysis, electronic and logical elements can be employed, all without exceeding the scope of the invention.

1. A method of optically monitoring a board game, comprising:
a) acquiring key frame images of said board game from a video stream, wherein each key frame of the board game is partitioned into an array of board squares images;
b) extracting shapes of game pieces from said images and training a machine learning module to distinguish between said game pieces and to detect whether each square is occupied or free, and if occupied, with a game piece of which player, and combining the extracted shapes into a matrix that represents the game pieces of each player and blank squares on the board game;
c) comparing each key frame image of said board game with a previous one in order to track movement and position of game pieces on said board game during a game session, wherein the extraction of game pieces shapes enables to complete missed or undefined moves; and
d) verifying the correctness of said movement according to game/tournament.

2. The method according to claim 1, further comprising transferring verified moves and relevant data to a remote server.

3. The method according to claim 2, wherein the verified moves are converted into an electronic notation format.

4. The method according to claim 1, further comprising detecting a sequence of played board game moves using a game engine that leads from one game board state to another, wherein the game engine is configured to process game sessions and to monitor their compliance with game/tournament rules by comparing and matching each detected move with pre-stored rules.

5. The method according to claim 4, further comprising recording timing of each played move, thereby enabling to act as a real-time game clock.

6. The method according to claim 4, further comprising detecting if more than one move occur from previous key frame to the next one, and applying a procedure for figuring the sequence of moves that leads from one board game state to another, by relying on the game/tournament rules, thereby enhancing the detection of the moves.

7. The method according to claim 1, further comprising monitoring the usage and state of an electronic chess clock along with board game state monitoring, such that the location of the clock's buttons which players press after the move was made is detected, and by measuring an optical flow at that region of image, the precise moment the move was finished is detected.

8. The method according to claim 1, further comprising simultaneously monitoring multiple game boards using a single camera.

9. The method according to claim 1, further comprising a scoring module adapted to provide scoring data to external players scoring systems thereby enabling to update players' ratings after a tournament or match, or after individual games.

10. The method according to claim 1, further comprising providing background subtraction algorithm to track objects that conceals parts of the board game, by maintaining the stationary state of a video stream which is considered as background and marks the regions of images which are different from the background to indicate moving objects.

11. A system of optically monitoring a board game, comprising:
a) a processing device adapted to detect moves and game data from key frame images received from video streams of said board game and to verify the correctness of said detected moves according to game/tournament rules as defined by a game engine, by partitioning each key frame image into an array of board squares images, extracting shapes of game pieces from said images and training a machine learning module to distinguish between said game pieces and to detect whether each square is occupied or free, and if occupied, with a game piece of which player, and combining the extracted shapes into a matrix that represents the game pieces of each player and blank squares on the board game, so that the extraction of game pieces shapes enables to complete missed or undefined moves;
b) at least one camera adapted to stream images of said board game to the processing device.

12. The system according to claim 12, in which a full view of the board game is obtained from at least one camera located above said board game.

13. The system according to claim 12, in which a full view of the board game is obtained from more than one camera, wherein the cameras are positioned in such a way that the lens of each camera will be able to provide at least partial view of said board game, while the combination of each camera enables to provide a full board view.

14. The system according to claim 12, further comprising a server adapted to receive and store the detected moves and the relevant game data.

15. The method according to claim 1, wherein the comparing of key frame images is done by computing an optical flow between said key frames, wherein said optical flow describes the transition from one key frame image to another.
